(19) United States
(12) Patent Application Publication
(10) Pub. No.: US 2022/0186063 A1
(43) Pub. Date: Jun. 16, 2022

(54) BEVERAGE STRAW COATED WITH AN ACTIVE COMPOUND AND METHOD OF MANUFACTURING

(71) Applicants: Mark Upsdell, Burlington (CA); Benjamin James Macphail, Burlington (CA); Annabelle Pfeifle, Burlington (CA); Karl Wirtz, Brampton (CA)

(72) Inventors: Mark Upsdell, Burlington (CA); Benjamin James Macphail, Burlington (CA); Annabelle Pfeifle, Burlington (CA); Karl Wirtz, Brampton (CA)

(21) Appl. No.: 17/548,174

(22) Filed: Dec. 10, 2021

Related U.S. Application Data
(60) Provisional application No. 63/123,737, filed on Dec. 10, 2020.

(51) Int. Cl. C09D 105/00; A47G 21/18

(52) U.S. Cl. CPC C09D 105/00; A47G 21/18

(57) ABSTRACT

A drinking straw having a coating on its interior surface is disclosed. The drinking straw has a coating on its interior surface. The coating comprises an active ingredient, a film forming agent, a non-ionic surfactant, and optionally a diluent. The active ingredient may be a cannabinoid. A method of manufacturing a straw having a coating on its interior surface is also disclosed. The method comprises combining the active ingredient with a carrier, and blending to form a mixture; adding a non-ionic surfactant and a plasticizer to the mixture; agitating the mixture to form a homogeneous first dispersion; adding a film forming agent to the first dispersion and mixing until homogeneous; applying the dispersion to the interior surface of the straw; agitating the straw to cover at least part of the interior surface with the first dispersion; and drying the first dispersion inside the straw to form the coating.

### CROSS REFERENCE TO RELATED APPLICATIONS

This application claims the benefit of U.S. Provisional Patent Application Ser. No. 63/123,737, filed Dec. 10, 2020, and Canadian Application Serial No. [--] entitled BEVERAGE STRAW COATED WITH AN ACTIVE COMPOUND AND METHOD OF MANUFACTURING, filed Dec. 9, 2021, the disclosures of which are incorporated herein by reference in their entireties.

### FIELD OF THE INVENTION

The present invention relates to a beverage straw having a coating that is used to deliver active compounds, and in one embodiment to a beverage straw having a coating that is used to deliver cannabinoid compounds. The present invention also relates to a process for manufacturing the beverage straw.

### BACKGROUND OF THE INVENTION

Currently, there are a number of solutions for the delivery of a flavoring or additive through the use of a drinking straw. Some require complex mechanical shapes in order to be effective, while others require components to retain the active ingredients, such as filters, sieves, endcaps and closures. Other solutions provide flavors using small beads or granules that need to be contained at each end of the straw. These solutions require multiple components and complex assembly, which increases costs. These solutions are not designed around the effective and efficient delivery of a desired compound.

Drinking straws are a quick and effective way to orally administer compounds, such as cannabinoids, to people that are unwilling or uninterested in ingesting the compound via more conventional means.

Cannabis products have been consumed in various forms for thousands of years for both therapeutic and recreational purposes. Some of the primary cannabinoids in cannabis are tetrahydrocannabinol, also known as THC, which is known in two forms: i) (−)-Δ⁹-THC, (6aR,10aR)-6,6,9-trimethyl-3-pentyl-6a,7,8,10a-tetrahydro-6H-benzo[c]chromen-1-ol) and ii) Δ⁸-THC, (6,6,9-trimethyl-3-pentyl-6a,7,10,10a-tetrahydrobenzo[c]chromen-1-ol); cannabidiol, also known as CBD (2-((1R,6R)-3-methyl-6-(prop-1-en-2-yl)cyclohex-2-enyl)-5-pentylbenzene-1,3-diol); cannabinol, also known as CBN (6,6,9-trimethyl-3-pentylbenzo[c]chromen-1-ol); cannabigerol, CBG (2-[(2E)-3,7-dimethylocta-2,6-dienyl]-5-pentylbenzene-1,3-diol); tetrahydrocannabivarin, THCV (6aR,10aR)-6,6,9-trimethyl-3-propyl-6a,7,8,10a-tetrahydrobenzo[c]chromen-1-ol); cannabidivarin, CBDV (2-[(1R,6R)-3-methyl-6-prop-1-en-2-ylcyclohex-2-en-1-yl]-5-propylbenzene-1,3-diol); cannabidiorcinol, CBDO (5-methyl-2-[(1˜{R},6˜{R})-3-methyl-6-prop-1-en-2-ylcyclohex-2-en-1-yl]benzene-1,3-diol) and cannabichromene, CBC (2-methyl-2-(4-methylpent-3-enyl)-7-pentylchromen-5-ol).

Certain of these compounds are found at least in part in their carboxylic acid forms, for example, THC as tetrahydrocannabinolic acid (THCA; (6aR,10aR)-2-carboxy-6,6,9-trimethyl-3-pentyl-6a,7,8,10a-tetrahydrobenzo[c]chromen-1-olate), CBD as cannabidiolic acid (CBDA; 2,4-dihydroxy-3-[(1R,6R)-3-methyl-6-prop-1-en-2-ylcyclohex-2-en-1-yl]-6-pentylbenzoic acid), and CBDV as cannabidivarinic acid (CBDVA; 2,4-dihydroxy-3-[(1R,6R)-3-methyl-6-prop-1-en-2-ylcyclohex-2-en-1-yl]-6-propylbenzoic acid).

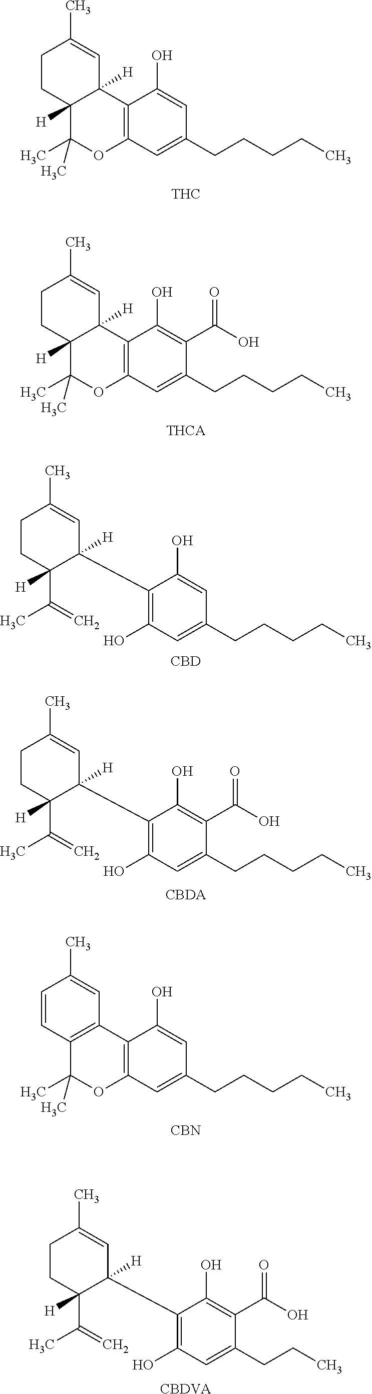

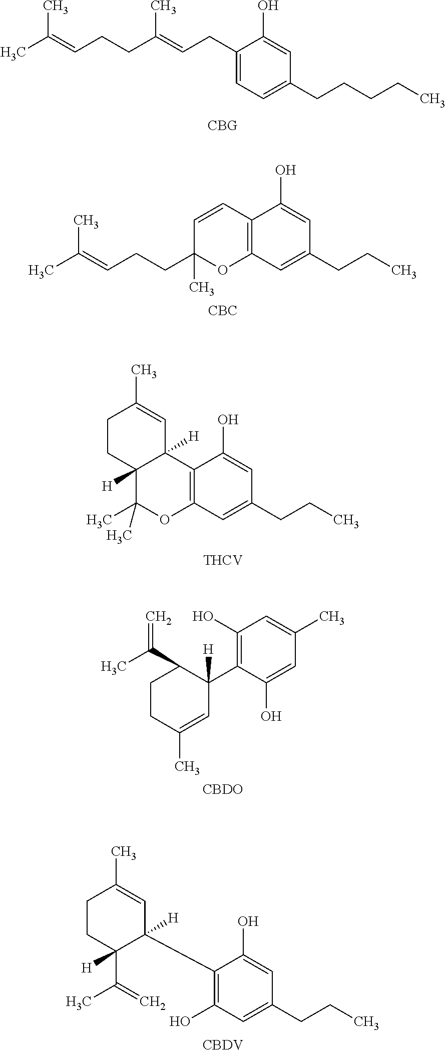

THC, or Delta-9-tetrahydrocannabinol, along with its metabolite, 11-OH-THC, are the principal psychoactive constituents of cannabis, each of which is a partial agonist of the cannabinoid receptors CB1 and CB2, both found in the human endocannabinoid system. Because THC is an illegal drug in many countries, clinical research about the medical use of this compound has been limited and often anecedotal in nature. The American Cancer Society has reported that patients with kidney cancer have required less pain medication when it was combined with cannabis extracts containing THC. Smoking cannabis has been found to alleviate nausea and vomiting in chemotherapy patients. Certain patients with suppressed appetite, including patients taking HIV drugs, have reported that smoking cannabis has improved and promoted food intake. Cannabis has also been documented as a pain relief agent, when inhaled. Cannabidiol (CBD) is one of the prominent active metabolites found in Cannabis plants, both the Cannabis sativa and Cannabis indica species. CBD has been reported to provide various therapeutic benefits such as antioxidant, anti-inflammatory, anti-anxiety and anti-epileptic properties, and is not known to cause psychotropic effects to users of CBD.

In contrast to THC, the ingestion of CBD is not known to cause psychotropic effects on its own, though it may attenuate effects of THC. CBD appears to act as an indirect antagonist of cannabinoid agonists, but does not appear to act at the CB1 and CB2 receptors, instead possibly acting as a 5HT1a receptor agonist. A recently published US report in 2017 by the National Academies of Science, Engineering and Medicine entitled Health Benefits of Cannabis and Cannabinoids, summarized the current understanding on the therapeutic use of cannabinoids such as THC and CBD, and highlighted several recommendation for their use in treating a variety of health problems and diseases.

CBD and THC have been purified to high purity, and, like many natural products of therapeutic interest, have also been synthetically and partially-synthetically produced.

It would be desirable to have a beverage straw that allows the user to consume an active compound, such as a cannabinoid, a pharmaceutical, and/or a nutraceutical, along with their chosen beverage. Furthermore, the use of the straw as the delivery system can assist those who may find difficulty in ingesting the active compound in other forms.

### SUMMARY OF THE INVENTION

According to an aspect of the invention, there is provided a drinking straw comprising a coating on its interior face, the drinking straw comprising the drinking straw; and the coating, wherein the coating comprises an active ingredient; a film forming agent; a non-ionic surfactant, and optionally a diluent.

In one embodiment, the active ingredient is a flavouring, nutritional supplement, vitamin, mineral, pharmaceutical, nutraceutical or a combination thereof. In another embodiment, the active ingredient is vitamin D3 (cholecalciferol), ascorbic acid (vitamin C), docosahexenoic acid (DHA), caffeine, nicotine, ubiquinone (coenzyme Q10), curcumin, natural antioxidants, glucosamine, melatonin, vitamin B12, a biologically active metabolite thereof such as methylcobalamin, iron, analgesic compounds such as acetaminophen, aspirin, ibuprofen and naproxen, antihistamines such as loratadine, desloratadine, cetirizine, levocetirizine and fexofenadine, cough suppressants such as dextromethorphan and pseudoephedrine, guaifenesin, antacids, histamine-2 blockers, proton pump inhibitors, simethicone, loperamide, bismuth subsalicylate, dimenhydrinate, cannabinoids, or a combination thereof.

In one embodiment, the film forming agent is pullulan, alginate salts, starches, pectins, dextrins, gelatins, glycogen, poly(vinylalcohol) and its derivatives including polyvinylacetate, polyethyleneoxide, polyethyleneglycol, and polyvinylpyrrolidone (povidone), or a combination thereof. In another embodiment, the non-ionic surfactant is SPAN™ 80 and/or TWEEN™ 80. In a further embodiment, the active ingredient is in a carrier oil, the carrier oil is medium chain triglyceride (MCT) oil, avocado oil, sunflower oil, grapeseed oil, or hemp seed oil.

In one embodiment, the drinking straw further comprises a diluent, which is maltodextrin.

According to another aspect of the invention, there is provided a drinking straw comprising a coating on its interior face, the drinking straw comprising the drinking straw; and the coating, wherein the coating comprises 30-55% w/w pullulan, 3-15% w/w MCT oil, up to 30% of cannabinoid, 5-25% w/w glycerol, 0.5-4% of a combination of TWEEN™ 80 and SPAN™ 80, and optionally 5-25% w/w maltodextrin.

According to another aspect of the invention, there is provided a method of manufacturing a straw comprising a coating on its interior face, the coating containing an active ingredient, the method comprising combining the active ingredient with a carrier, and blending to form a mixture; adding a non-ionic surfactant and a plasticizer to the mixture; agitating the mixture to form a homogeneous dispersion; adding a film forming agent to the dispersion and mixing until homogeneous; applying the dispersion to the interior of the straw; agitating the straw to cover the interior face with the dispersion; drying the dispersion inside the straw to form the coating.

In one embodiment, the method further comprises adding maltodextrin to the mixture along with the non-ionic surfactant and the plasticizer. In a further embodiment, the active ingredient is a cannabinoid, the non-ionic surfactant is one or more of TWEEN™ 80 and SPAN™ 80, the plasticizer is glycerol, and the film forming agent is pullulan.

In one embodiment, after the dispersion has dried, the method further comprises applying a second dispersion comprising a second active ingredient to the interior of the straw, agitating the straw to cover the dried dispersion with the second dispersion, and drying the second dispersion inside the straw.

In another embodiment, after the dispersion has been applied to the straw, the method further comprises placing the straw horizontally to coat about half of the circumference of the straw, after the dispersion has dried, rotating the straw about 180° and applying a second dispersion having a second active ingredient to the interior of the straw to coat the opposing half of the circumference of the straw, and drying the second dispersion inside the straw.

### BRIEF DESCRIPTION OF THE DRAWINGS

The present invention will now be described in more detail having regard to the drawings in which:

FIG. 1 is a cross-sectional view of a drinking straw according to an embodiment of the invention;

FIG. 2 is a flow chart showing a method according to an embodiment of the invention;

FIG. 3 is a graph showing the THC concentration percentage, in both the straw and the coating, from straws prepared according to an embodiment of the invention;

FIG. 4 is a graph showing the number of coated straws that were rejected while manufacturing various batches of straws according to an embodiment of the invention;

FIG. 5 is a graph showing the percentage of the total dose of THC in the coating of a straw prepared according to an embodiment of the invention, which is released as a fluid passes through the straw;

FIG. 6 is a graph showing the volume of liquid that is required to fully dissolve the coating of a straw prepared according to an embodiment of the invention, with various amounts of maltodextrin in the coating;

FIG. 7 is a graph showing the volume of liquid that is required to fully dissolve the coating of a straw prepared according to an embodiment of the invention, with various amounts of glycerol in the coating;

FIG. 8 is a graph comparing the percentage of the total dose of CBD in the coating, of a straw prepared according to various embodiments of the invention that is released as a fluid passes through the straw at defined timepoints; and

FIG. 9 is a graph comparing the percentage of the total dose of CBD in the coating, of a straw prepared according to various embodiments of the invention, that is released as a fluid is drawn up through the straw, that is retained on the straw, or that remains in the liquid reservoir.

### DETAILED DESCRIPTION

The invention may be more fully appreciated by reference to the following description, including the concluding examples.

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Percentages of components of the dispersion are listed as % w/w of the dried coating. These percentages do not include the weight of the water in the % w/w total as the water content is substantially removed from the dried coating. Therefore, the listed % w/w amounts are inclusive of only the coating ingredients that are found in the dried dispersion on the straw.

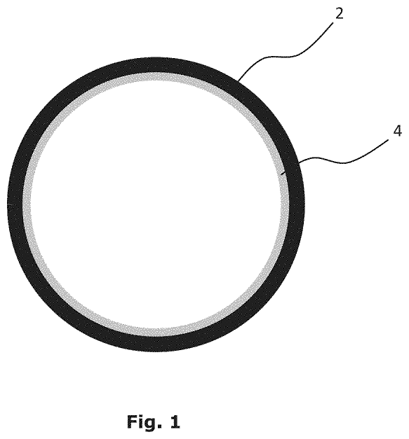

As can be seen in FIG. 1, the present invention is directed to a beverage straw 2 having its internal face coated with a dispersion 4 that contains a desired compound. The dispersion 4 is dried to form a coating that adheres to the internal face of the straw 2. The coating 4 at least partially dissolves as liquid passes through the straw, releasing the desired compound into the liquid for consumption.

The straw 2 may be a standard conventional tubular drinking straw having opposing open ends, and an interior face. The straw may be made from plastics, metal, silicone, compostable, or biodegradable materials, including bamboo, paperboard, wheat, sugarcane, rice, and seaweed.

While the adhered dispersion may contain a single desired compound, it is possible that more than one desired compound can be included. In another embodiment, the straw may be coated with more than one dispersion, with each dispersion containing a different desired compound. Such a straw allows for the successive delivery of multiple compounds. In an alternative embodiment, a portion of the straw may be coated with a first dispersion having a first desired compound, while a separate portion of the straw may be coated with a second dispersion having a second desired compound. Such a straw allows for the simultaneous delivery of multiple compounds.

The desired compound may be any flavouring, nutritional supplement, vitamin, mineral, pharmaceutical, nutraceutical or combination thereof. Exemplary desired compounds vitamin D3 (cholecalciferol), ascorbic acid (vitamin C), docosahexenoic acid (DHA), caffeine, nicotine, ubiquinone (coenzyme Q10), curcumin, natural antioxidants, glucosamine, melatonin, vitamin B12, a biologically active metabolite thereof such as methylcobalamin, iron, analgesic compounds such as acetaminophen, aspirin, ibuprofen, and naproxen, antihistamines such as loratadine, desloratadine, cetirizine, levocetirizine fexofenadine, cough suppressants such as dextromethorphan, pseudoephedrine, guaifenesin, antacids, histamine-2 blockers, proton pump inhibitors, simethicone, loperamide, bismuth subsalicylate, dimenhydrinate, and cannabinoids.

The desired compound may be a cannabinoid compound, including cannabidiol (CBD), delta-9-tetrahydrocannabinol, delta-8-tetrahydrocannabinol, cannabigerol, cannabidiol acid, tetrahydrocannabinol acid, or blends of CBD and THC, preferably present in a relative weight ratio of between 20:1 to 1:20 (CBD:THC).

In one embodiment, in addition to the one or more desired compounds, the dispersion comprises a water-soluble component/film forming agent. The film forming agent provides structure to the dispersion. As liquid flows through the straw, the water-soluble component slowly dissolves, thereby allowing the desired compound to leach out of the coating. The water-soluble component can be pullulan, alginate salts, starches, pectins, dextrins, gelatins, glycogen, poly(vinylalcohol) and its derivatives including polyvinylacetate, polyethyleneoxide, polyethyleneglycol, and/or polyvinylpyrrolidone (povidone).

The dispersion may also optionally also contain one or more of a non-ionic surfactant, such as SPAN™ 80 (sorbitan monooleate) and TWEEN™ 80 (polyoxyethylene sorbitan monooleate) or the like, a plasticizer, such as glycerol, propylene glycol, low molecular weight polyethylene glycols, citrates and derivatives, and triacetin a colourant, a flavouring agent, a sweetener such as steviol glycosides, glucose, high fructose corn syrup, neotame, sorbitol, saccharin, sodium saccharin, sucralose, xylitol, aspartame, acesulfame potassium, erythritol, and advantame, and a permeation enhancer such as thiolated polymers, menthol, dimethyl sulfone, and cyclodextrins. The dispersion may also contain a diluent such as maltodextrin, crosspovidone, sodium starch glycollate, polacrilin potassium, or glycerol.

In some instances, it may be necessary to combine the desired compound with a carrier, such as medium chain triglyceride (MCT) oil, avocado oil, sunflower oil, grapeseed oil, or hemp seed oil, to facilitate mixing of the desired compound with the dispersion.

The dispersion may be then combined with water to make an aqueous solution. The water content relative to solids content is optimally between 55%-80% water and 20%-45% solids.

According to one aspect of the present invention there is provided a drinking straw having a coating, in which the coating comprises pullulan, a cannabinoid optionally dissolved in MCT oil, maltodextrin, TWEEN™ 80, and SPAN™ 80. Optionally, the coating further comprises glycerol.

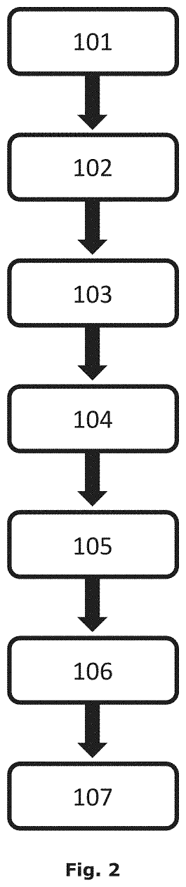

According to one aspect of the present invention there is provided a method of manufacturing the beverage straw (See FIG. 2).

Depending on the properties of the desired compound, in some embodiments it may be optionally mixed with a carrier 101 prior to being introduced to the remaining components of the dispersion. The amount of the desired compound in the dispersion may vary depending upon various factors, including the intended dosage of the compound in each straw and the number of straws to be coated with each batch of the dispersion, and may account for up to 30% of the dispersion. The proportion of the carrier to the desired compound may vary, but preferably, the minimal amount of carrier is used until the miscibility and viscosity of the mixture is sufficient to form a homogeneous mixture with the subsequent components. In some embodiments, the dispersion may comprise 3-15% of the carrier. In some cases, it may be necessary to heat the mixture, such as up to e.g. 170° F., to fully dissolve the desired compound in the carrier.

The desired compound, which may be in admixture with a carrier, is mixed 102 with 0.5%-4% of a non-ionic surfactant, 5%-25% of a plasticizer, such as glycerol, along with water to make an aqueous mixture. Optionally, less than 1.5% of a colourant, 1%-5% of a flavouring agent, 0.5%-10% of a sweetener, 0.1%-3% of a permeation enhancer, and 5%-25% of a diluent such as maltodextrin may be added. The aqueous mixture is mixed, such as manually or with e.g. a stirring plate or paddle mixer, until it is homogeneous.

After the aqueous mixture has been formed, it is mixed 103 with the water-soluble film forming agent. The water-soluble film forming agent may form about 0% to 55% of the dispersion. This mixture is again mixed until it is homogenous, and any particulates are substantially dissolved. Optionally, the water-soluble component can be added to the desired compound in step 102 with the other listed components.

The dispersion is applied to the interior 104 of the straws. Depending upon the number of straws to be prepared, this can be either done manually, or when a large batch is to be prepared, this step can be automated.

When applying the dispersion to the interior of the straw manually, the dispersion is dispensed using a pipette to inject the exact amount of dispersion prescribed for the dose. When using an automated process to apply the dispersion to the interior of the straw the dispersion should be injected using a syringe pump, ideally one with repeating functionality.

The amount of mixture to apply to each straw will be dependent upon which desired compound is utilized, and the corresponding intended dose for that compound. In some embodiments, multiple applications of the aqueous mixture are needed to ensure that the amount of compound in each straw reaches or at least approaches the target amount. Optionally, after the mixture has been applied, the straws can be agitated or tilted, such as on a rocker or a shaker, or by placing the straws at an incline. This will allow the dispersion to more evenly distribute throughout the interior of the straw. However, care should be taken to minimize allowing the mixture to exit the interior of the straw.

The coated straws are subjected to drying 105 to adhere the dispersion to the interior surface of the straws by removing the bulk water content within the formulation. Preferably, the drying step is accomplished by passing air through the straws. This can be done in either a heated or room temperature environment. In one embodiment, the straws are placed in a convection oven that has been set to a low temperature, such as 100-150° F. Preferably, the straws are oriented so that the airflow within the oven passes through the straws. Alternatively, the straws can be placed in an environment with increased air flow, such as a room outfitted with fans. This step can also occur passively, in which the straws are stored, and the dispersion is permitted to dry. Alternatively, conduction heating could be used to heat the straws to allow the straws to dry. In this embodiment, low temperatures are required to prevent the straw from melting and the dispersion from drying unevenly.

Once the straws have sufficiently dried, they are ready for packaging 106. Optionally, straws can be wrapped individually, which may be preferable as it may minimize the moisture that can access the coating on the interior of the straw. The packaged straws may be stored in a cool environment having a relative humidity ranging from 40% to about 55%.

In another embodiment, after a coating containing a first desired compound is applied to the straw has dried, a second coating containing a second desired compound may be applied. In this embodiment, the first desired compound will not be released into a liquid passing through the straw until at least a portion of the second coating has dissolved, so two desired compounds can be delivered successively.

In a further embodiment, after the dispersion is applied to the straw, it may be tipped so that the dispersion extends the length of the straw, but it is not agitated or rotated. The straw is then set horizontally to dry. The dispersion will dry into a coating that covers a portion, e.g. about half, of the interior surface of the straw in the lengthwise direction, while leaving at least a portion of the interior surface of the straw uncoated. The straw is then rotated about 180°, and a second dispersion containing a second desired compound is applied to the straw. The straw may be tipped so that the second dispersion extends the length of the straw, and is then placed horizontally to allow it to dry a second time. The straw will have two distinct coatings, each covering a portion of the interior surface of the straw that allows for concomitant delivery of two distinct desired compounds.

In a still further embodiment, the multiple coatings of the straw are not in the lengthwise direction. Rather, a first dispersion is applied circumferentially to the interior surface of a portion of the straw, such as a quarter, a third, or a half of the length of the straw, leaving the opposing portion of the interior face of the straw uncoated. A second dispersion may then be applied circumferentially to the interior surface of the opposing end of the straw. Such an application may be performed by dipping the straw in the dispersion, and if desired, wiping the excess off the exterior of the straw. Once the dispersions have dried, the interior surface of the straw will have two distinct coatings that allows for concomitant delivery of two distinct compounds.

### EXAMPLES

### Example 1

Batch Preparation of 10 mg THC Straws

A hot water bath with a sous vide temperature controller (76.6° C./170° F.) was used to heat THC distillate until its viscosity is reduced to a free-flowing material. The following ingredients were then dispensed into a 250 mL beaker:
THC distillate 42.45 g
MCT Oil 65.45 g

The beaker was placed on a hot plate (170° F.) to dissolve the THC while stirring by hand with a metal stir rod until a homogeneous solution is achieved.

Into a separate clean 1000 mL beaker, the following components were added:

TABLE 1

| Component | Amount |
|---|---|
| THC/MCT Oil mixture | 26.92 g |
| Glycerol | 16.36 g |
| Polysorbate 80 | 5.95 g |
| Sorbitan Monooleate | 5.95 g |
| Water | 595 g |

The resulting emulsion was sonicated at 90% amplitude for 5 minutes (59 s on, 30 s off pulsing) with a probe sonicator.

To the resulting sonicated emulsion, 93.56 g of Pullulan was added into the beaker. The emulsion along with the Pullulan was premixed manually, and then an overhead mixer was utilized at 300 RPM to mix the dispersion until it was homogeneous. The dispersion was mixed until all lumps had been dispersed yielding a smooth, opaque, white-yellowish solution. A second dispersion was created using the same technique for immediate use the following day when production continued so as to prevent the dispersion from separating into phases.

Prior to applying the dispersion to the straws, pipettes were calibrated to calculate what volume of the dispersion would equate with the desired mass of the dispersion.

In this case, the intended target mass for each straw's dispersion injection was 850 mg to deliver the desired 10 mg of THC. Once the correct volume was calculated, the dispersion was injected into PFTA (Plants Fiber Tech Alliance) sugarcane straws by gently inserting the pipette tip approximately 2 inches into one end of the straw and depressing the plunger all the way down. The pipette tip was wiped against the inside of the straw to ensure any residual dispersion on the pipette tip is properly administered to the interior of the straw. Each pipette tip was free from residual dispersion before injecting the next straw. The dispersion was occasionally stirred to prevent phase separation.

Dispersion mass for every 20 straws made was recorded. This was accomplished by measuring the mass of an empty straw on an analytical balance, injecting the straw with dispersion, then weighing the straw once more to ensure the correct amount of dispersion was administered to each straw. In this batch, 2,404 straws were manufactured, and the average mass of the dispersion applied to each straw was 833.69 mg.

After application of the dispersion, the straws were tipped at about a 20⁰ angle to allow the dispersion to coat the interior of the straws. Care was taken to ensure that the dispersion did not run out of the end of the straws. Room temperature air was blown through each straw using a heat gun to ensure the dispersion coated the interior of the straw evenly.

Residual loss (as dry weight) was recovered from the mixing vessel, containment units, pipettes, and any dispersion-contacting equipment used (i.e. spatulas, spoons etc.), and then weighed.

The straws were baked to dry the dispersion. A convection oven was pre-heated to 55° C. The injected straws were affixed to the tray using a polymer sheet. The polymer sheet was taped directly to each tray, which was then labelled and numbered.

The trays were placed into the convection oven, ensuring the straws are oriented parallel with the flow of air within the oven. Straws were randomly inspected from each tray every 30 minutes to see if the dispersion had dried (dispersion is immobile when straw is tilted). Once the straws were dry, the trays were removed from the oven. Drying times varied as will be discussed in Example 2 below.

Straws were allowed to cool down to room temperature. Once cooled, they were placed in an airtight bag and covered until ready for packaging.

Some straws were wrapped individually using foil, and the open ends of the foil packaging were heat sealed. Individual straws were labelled with a lot number, batch number, date of manufacturing, and the tray the straw was obtained from. The appropriate number of loose or individually wrapped straws was placed into a box. Each box was labelled with the lot number, batch number, number of straws in the box, date of manufacturing, and which tray the straws were obtained from. The appropriate cannabis label was affixed to each box.

Boxes were stored in totes labelled with the number of boxes, number of straws, and the additional information as noted above.

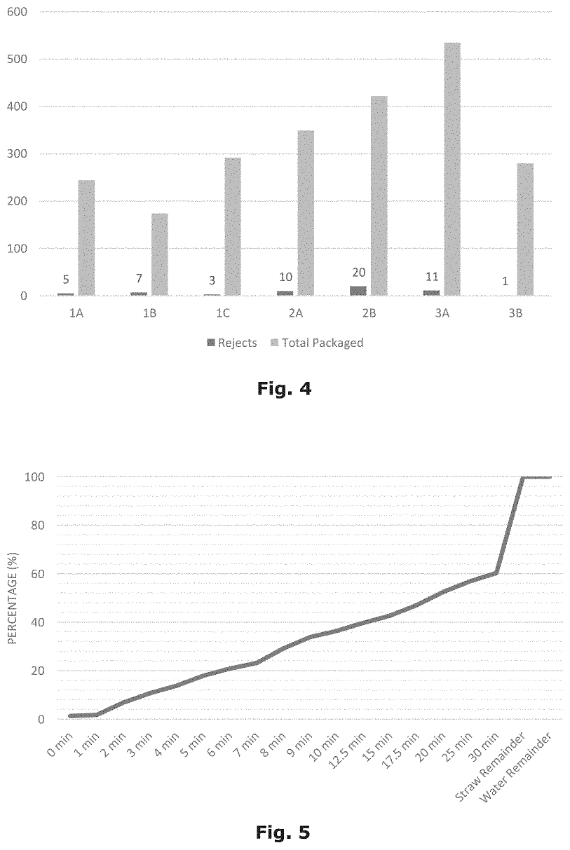

Some straws that did not meet quality control specifications were rejected. Specifically, a straw was rejected if it was outside of 10% of the defined finished product mass of 1.085 g for unit, outside of 15% of the defined 10 mg dose of THC, or finally, did not pass a visual inspection in which the straw needs to be dried completely and evenly (no flaking of coating are visible). FIG. 4 shows that only a relatively small number of straws did not meet control standards during the manufacturing process.

### Example 2

Effect of Drying Times on Dose

A study was performed to investigate whether drying time of the dispersion affects the amount of THC that adheres to the straw. During the preparation of straws described in Example 1, various separate batches were prepared in which the drying time was varied as noted in Table 2.

TABLE 2

| Batch Number | Drying Time |
|---|---|
| 1A | 187 minutes |
| 1B | 162 minutes |
| 1C | 184 minutes |
| 2A | 181 minutes |
| 2B | 187 minutes |
| 3A | 177 minutes |
| 3B | 198 minutes |

Processing of the straw samples included cutting the straw lengthwise, and the dried dispersion lining the interior of the straws was removed by peeling the coating off the straw, aided by a spatula if necessary. The straw and the film for each batch was added to separate volumetric flasks and weighed. 40 mL of HPLC-grade water was added to each flask and shaken until a homogeneous solution was achieved. The flasks were filled to volume with HPLC-grade methanol and inverted 30 times. 1 mL of each solution was filtered into separate 5 mL volumetric flasks and filled to volume with 80:20 methanol. An aliquot of each solution was added to a sample vial.

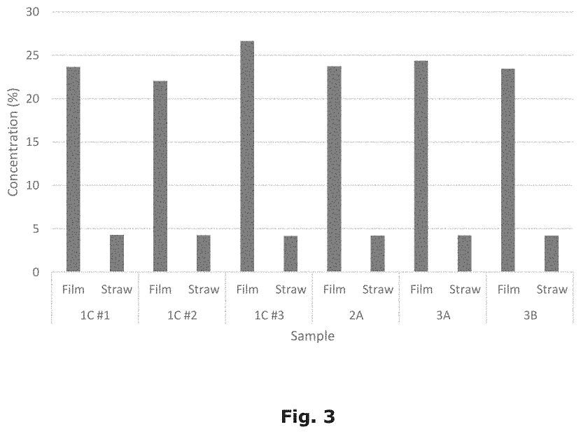

The samples were analyzed by HPLC to assess the amount of THC present in the coated straws. Results are shown in FIG. 3, in which it can be seen that the separate batches of the dispersion contained similar amounts of THC regardless of the drying times.

### Example 3

Assessment of Dosage of Cannabinoid in Prepared Straws

A study was performed to assess the dosage of cannabinoid in the manufactured straws. The dispersion was prepared as in Example 1, with an intended dose of 10 mg of THC per straw.

Samples for analysis were prepared as follows:
Sample 1: Sample of dispersion prior to application to straw at 200× dilution
Sample 2: Sample of dispersion prior to application to straw at 1000× dilution
Sample 3: Ground up coated straw
Samples 4-6: 3 coated straws cut lengthwise and the dried film/coating removed.
Sample 7: Coated straw cut into smaller pieces with increased extraction time and water (shaken for 20 min, left for 30 min, shaken again).

For samples 1 and 2, an aliquot of 80:20 methanol was pipetted into a sample vial for analysis (blank). A new straw dispersion was prepared as in Example 1. 881.9 mg was dispensed into a 200 mL volumetric flask. 40 mL of HPLC-grade water was added and the flask was shaken until homogeneous. HPLC-grade methanol was added to volume and the flask was inverted 30 times. An aliquot of this solution was filtered and placed into a sample vial (sample 1 200× dilution). An additional 1 mL of this solution was filtered and placed into a 5 mL volumetric flask. This was diluted to volume with 80:20 methanol and shaken. An aliquot of this sample was placed in a sample vial (sample 2 1000× dilution).

For sample 3, a dried coated straw was cut up into smaller pieces and ground up using a coffee grinder. Particulates were transferred to a 200 mL volumetric flask and weighed. 40 mL of HPLC-grade water was added and the flask was shaken until all the dispersion went into solution. The flask was filled to volume with HPLC-grade methanol and inverted 30 times. 1 mL of this solution was filtered into a 5 mL volumetric flask and filled to volume with 80:20 methanol. The flask was shaken and an aliquot of this solution was placed in a sample vial.

For samples 4-6, three straws were carefully cut lengthwise and the dried dispersion lining the interior of the straws was removed by peeling the coating off the straw, aided by a spatula if necessary. This was added to 3 separate 200 mL volumetric flasks and weighed (168.7 mg, 155.5 mg, and 156.2 mg). 40 mL of HPLC-grade water was added to each flask and shaken until a homogeneous solution was achieved. The flasks were filled to volume with HPLC-grade methanol and inverted 30 times. 1 mL of each solution was filtered into separate 5 mL volumetric flasks and filled to volume with 80:20 methanol. An aliquot of each solution was added to a sample vial.

For sample 7, one coated straw was cut into smaller pieces (with scissors) and placed into a 200 mL volumetric flask with the weight recorded (1170.6 mg). 50 mL of HPLC-grade water was added and the flask was shaken for 20 minutes. The flask was allowed to sit for 30 minutes before being shaken again until all the dispersion went into solution. The flask was filled to volume with HPLC-grade methanol and the flask was inverted 30 times. 1 mL of this solution was filtered into a 5 mL volumetric flask and filled to volume with 80:20 methanol. An aliquot of this solution was added to a sample vial.

The samples were analyzed by HPLC to assess the amount of THC present in the coated straws. Results are shown in Table 3 below.

TABLE 3

| | | | Amount from | |
|---|---|---|---|---|
| | Weight | P.A of | HPLC raw | Dosage |
| Sample | (mg) | d9-THC | data (mg) | (mg) |
| 1 | 881.90 | 1019276 | 0.060 | 11.94 |
| 2 | 881.90 | 142995 | 0.010 | 10.17 |
| 3 | 1141.20 | 796045 | 0.047 | 9.41 |
| 4 | 168.70 | 858432 | 0.051 | 10.12 |
| 5 | 155.50 | 776452 | 0.046 | 9.19 |
| 6 | 156.20 | 791283 | 0.047 | 9.36 |
| 7 | 1170.60 | 845250 | 0.050 | 9.97 |

Regardless of the sample preparation, the straws contained close to the desired dosage of 10 mg of THC, indicating that the coating process was generally reliable and reproducible.

### Example 4

Assessment of Residual THC in Straw after Dispersion has been Removed

A study was performed to assess whether there is any leftover THC residue in the straws after the dried dispersion has been extracted.

Three coated straws, prepared as in Example 1 and that contain an estimated 10 mg of THC each, were obtained. Each of these straws was cut lengthwise and the dried coating were removed by peeling the coating off the straw, aided by a spatula if necessary. Each of these dried coatings was added to a tared 200 mL volumetric flask and weighed. The respective straws were added to separate 200 mL volumetric flasks and weighed.

50 mL of HPLC-grade water was added to each flask and shaken vigorously for 10 minutes to ensure all of the dried dispersions fully dissolved and went into solution. The flasks were filled to volume with HPLC-grade methanol and inverted 30 times each. An aliquot of each solution was filtered into HPLC sample vials. An 80% methanol solution was added to a sample vial to act as a blank solution.

The samples were analyzed by HPLC to assess the amount of THC present. Results are shown in Table 4 below.

TABLE 4

| | | | Amount | | |
|---|---|---|---|---|---|
| | | P.A | from | | |
| | Weight | of d9- | HPLC raw | Conc, | Dosage |
| Sample name | (mg) | THC | data (mg) | % | (mg) |
| Straw 1 Coating | 184.8 | 944517 | 0.055 | 6.002 | 11.09 |
| Straw 1 Straw | 1005.8 | 0 | 0.000 | 0.000 | 0.00 |
| Straw 2 Coating | 177.0 | 885255 | 0.052 | 5.888 | 10.42 |
| Straw 2 Straw | 1000.6 | 0 | 0.000 | 0.000 | 0.00 |
| Straw 3 Coating | 171.3 | 824712 | 0.049 | 5.685 | 9.74 |
| Straw 3 Straw | 992.2 | 0 | 0.000 | 0.000 | 0.00 |

As can be seen, once the dried dispersion has been extracted, there does not appear to be any THC that has leached into the material of the straw itself.

### Example 5

Assessment of Water Required to Pass Through Straw to Remove THC from the Dispersion

A study was performed to determine how long it takes for CBD to be released from the coating as a liquid is drawn through the coated straw, and to determine how much liquid is required to achieve the full dose of the active ingredient.

In this study, the dispersion was prepared as in Example 1, with the following formulation to make a master batch:

| | |
|---|---|
| Pullulan | 3.2590 g |
| Glycerol | 0.9974 g |
| Tween 80 | 0.3503 g |
| Span 80 | 0.3596 g |
| MCT oil | 0.9946 g |
| CBD distillate | 2.6818 g |
| Water | 34.1565 g |

The volume of dispersion required to achieve a 10 mg dose of THC was calculated. A pipette was calibrated to ensure that it dispenses the correct amount of dispersion to achieve the desired dose, and then it was loaded with the appropriate amount of the dispersion.

Five injections of dispersion was dispensed using the pipette into an empty beaker to ensure that the correct mass of the dispersion is dispensed each time.

The calculated amount of dispersion was injected using the pipette into PFTA sugarcane straws. The dispersion was allowed to gradually coat the inside of each straw by arranging them vertically. Care was taken to not allow the dispersion to come out of the bottom of the straws.

Straws were dried by taping them horizontally to a tray using food-grade mylar and placing the tray into a convection oven at 55° C. for approximately 60 minutes or until dispersion was visibly dry. Straws were checked every 30 minutes. Once the straws were dry, they were removed from the oven and allowed to cool.

For each straw, a syringe was affixed to the end of a prepared coated straw. The opposing end of the straw was placed in a beaker of deionized water.

The syringe was used to draw 10 ml of water up from the beaker through the straw at the following predetermined time points: 5 s, 30 s, 1 min, 1.5 min, 2 min, 2.5 min, 3 min, 3.5 min, 4 min, 4.5 min, 5 min, 6 min, 7 min, 8 min, 9 min, 10 min, 12.5 min, 15 min, 17.5 min, 20 min, 25 min, and 30 min. Each 10 ml aliquot of water was placed in a separate tube for analysis.

After the last sample had been collected at the 30 min time point, the straw was cut into small pieces and added to a flask with water to assess how much THC remained in the straw. Some of the residual water remaining in the beaker was also sampled to see if any of the THC migrated into the beaker from the bottom of the straw.

HPLC-grade methanol was added to each sample up to 50 ml, and the samples were shaken vigorously.

As a control to account for how much THC was in the straw at time zero, a separate coated straw was cut into small pieces. These pieces were placed into a clean 200 mL volumetric flask and a small amount of 80:20 methanol was added. The solution was shaken vigorously. After adding 80:20 methanol, it was shaken again and filtered into an HPLC vial.

The composite results from all six straws are shown in FIG. 5, in which it can be seen that after 220 ml of water passes through the straw over a span of 30 minutes, approximately 60% of the THC has been released from the coating.

### Example 6

Assessment of Dispersion Dissolution Rates

A study was conducted to see whether variation in certain components of the dispersion, or the amounts of these components, would impact the dissolution rate of the dried dispersion.

Dispersions were prepared in which the glycerol content was varied, or maltodextrin was added in various amounts, to assess if the time until full dissolution was affected by either of these alterations.

The dispersions were prepared as in Example 1, with the formulations for the maltodextrin dispersions listed in Table 5, and the formulations for the glycerol dispersions listed in Table 6. No desired compound, such as THC or CBD was included in this study. Although, in this study, the coating was coloured so that dissolution could be visually assessed.

TABLE 5

| | 3% | 7% | 10.8% | 15.8% | 20.8% |
|---|---|---|---|---|---|
| | Malto- | Malto- | Malto- | Malto- | Malto- |
| | dextrin | dextrin | dextrin | dextrin | dextrin |
| Pullulan (g) | 4.0752 | 3.7251 | 3.4040 | 2.9911 | 2.5639 |
| TWEEN ™ 80 | 0.3488 | 0.3498 | 0.3518 | 0.3501 | 0.3593 |
| (g) | | | | | |
| SPAN ™ 80 | 0.3634 | 0.3451 | 0.3586 | 0.3344 | 0.3390 |
| (g) | | | | | |
| Glycerol (g) | 1.4464 | 1.5180 | 1.4665 | 1.5514 | 1.4537 |
| MCT Oil (g) | 2.0571 | 2.0782 | 2.0746 | 2.0699 | 2.0730 |
| Colour NP- | 0.0493 | 0.0618 | 0.0591 | 0.0563 | 0.0512 |
| SPIR B2 (g) | | | | | |
| Maltodextrin | 0.2621 | 0.6008 | 0.9210 | 1.349 | 1.7767 |
| (g) | | | | | |
| Water (g) | 34.1890 | 34.0271 | 34.0077 | 34.04 | 34.1932 |

TABLE 6

| | 9% Glycerol | 13% Glycerol | 17% Glycerol |
|---|---|---|---|
| Pullulan (g) | 5.0196 | 4.6788 | 4.3336 |
| TWEEN ™ 80 (g) | 0.3540 | 0.3432 | 0.3696 |
| SPAN ™ 80 (g) | 0.3872 | 0.3820 | 0.3742 |
| Glycerol (g) | 0.8007 | 1.1571 | 1.4448 |
| MCT Oil (g) | 2.0672 | 2.0632 | 2.0750 |
| Colour NP-SPIR B2 (g) | 0.0410 | 0.0429 | 0.0519 |
| Water (g) | 33.9897 | 34.4627 | 34.0113 |

Each of the dispersions was coated on straws as in Example 1. For each straw, a syringe was affixed to the end of a prepared coated straw. The opposing end of the straw was placed in a beaker of deionized water. Water was drawn incrementally through each straw until the coloured coating was no longer visible inside the straw, i.e. the coating was substantially fully dissolved. The amount of water necessary to fully dissolve each coating was noted.

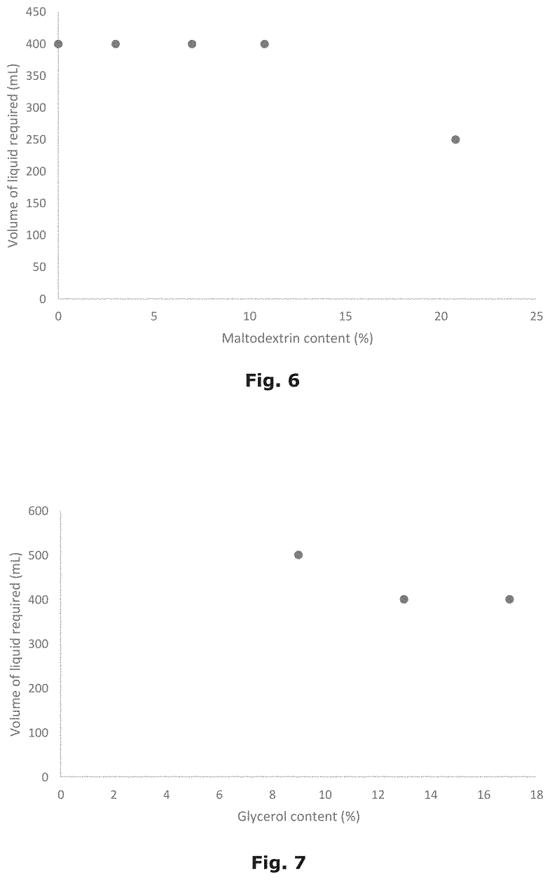

The results of the study are represented in FIGS. 6 and 7, in which it can be seen that higher glycerol and maltodextrin content led to less water being required to dissolve the coating.

### Example 7

Further Assessment of Dispersion Dissolution Rates

A further study was conducted to see whether including maltodextrin at various amounts would impact the dissolution rate of the dried dispersion.

In this study, the dispersions were prepared as in Example 1, with the following formulations for the master batches:

TABLE 5

| | Sample A | Sample B | Sample C | Sample D | Sample E |
|---|---|---|---|---|---|
| Maltodextrin | 0.3991 | 0.2837 | 0.2045 | 0.1154 | 0 |
| (g) | | | | | |
| Pullulan (g) | 0.5110 | 0.6447 | 0.6842 | 0.7953 | 0.9154 |
| Glycerol (g) | 0.3041 | 0.2889 | 0.2881 | 0.3273 | 0.3080 |
| TWEEN ™ 80 | 0.0958 | 0.0827 | 0.0830 | 0.0813 | 0.0818 |
| (g) | | | | | |
| SPAN ™ 80 | 0.0904 | 0.0773 | 0.0787 | 0.0701 | 0.0897 |
| (g) | | | | | |
| MCT Oil (g) | 0.1968 | 0.1899 | 0.1940 | 0.2021 | 0.2120 |
| CBD Isolate | 0.2270 | 0.2180 | 0.2094 | 0.2351 | 0.2173 |
| (g) | | | | | |
| Water (g) | 4.0721 | 4.0659 | 3.9771 | 3.9902 | 3.9739 |

The volume of the dispersion required to deliver a 20 mg dose of CBD to a straw in a single injection was calculated, and a pipette was calibrated accordingly. Five test injections of the dispersion were made into an empty beaker to ensure that the correct mass of the dispersion is delivered per injection.

Into five separate PFTA sugarcane straws, a single injection of the dispersion was delivered. The dispersion was allowed to gradually coat the inside of each straw by arranging them vertically. The straws were monitored to ensure that the dispersion did not come out of the bottom of the straw.

The dispersion was dried in the straws by taping them horizontally to a tray using food-grade mylar and placing the tray into an oven at 55° C. for approximately 60 minutes or until dispersion was visibly dry. Straws were checked every 30 minutes. Once the dispersion was dry, straws were removed from the oven and allowed to cool.

A syringe was attached to an end of a coated straw, while the opposing end was placed in a 355 ml beaker of water. Using the syringe, 10 ml of water was drawn through the straw at intervals of 0 min, 3 min, 6 min, 9 min, 12 min, 15 min, 18 min, 21 min, 24 min, 27 min, and 30 min. Each collected 10 ml sample was placed in a tube for subsequent analysis. A 10 mL sample of the remaining water in the 355 ml beaker was collected and placed in a tube for subsequent analysis.

After the final sample was withdrawn, the straw was cut into small pieces and placed inside a 200 ml volumetric flask. As a control, a separate unused coated straw was also cut into small pieces and placed in another 200 ml flask. 40 ml of deionized water was added to each flask, and they were vigorously shaken. The volume of each flask was diluted with HPLC-grade methanol. The solution is then filtered into an HPLC vial.

Each of the collected samples was supplemented up to 50 ml with HPLC-grade methanol and shaken vigorously until homogeneous.

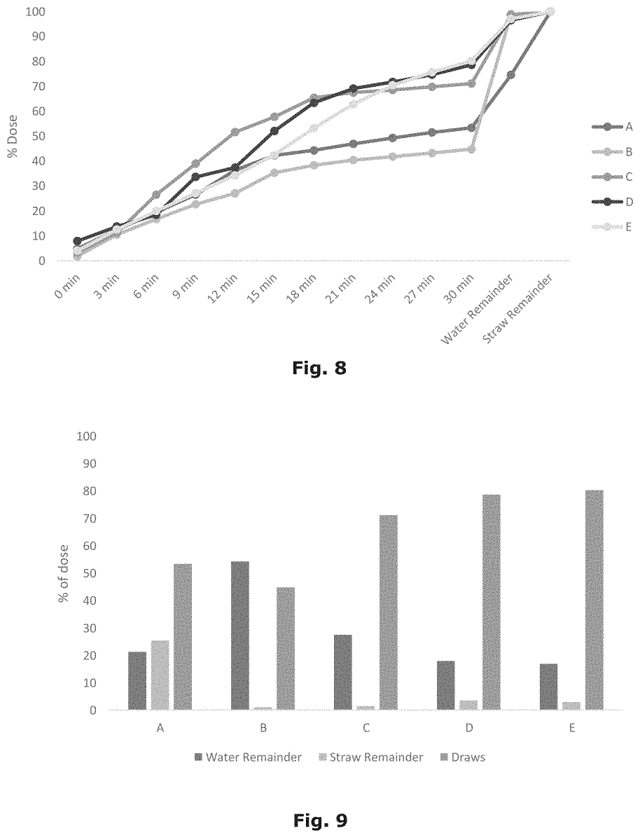

Samples were analyzed via HPLC, and the results can be seen in FIGS. 8 and 9.

In addition to the results shown in FIGS. 8 and 9, during the study, the following observations were made:

Sample A—the dispersion was somewhat runny, which made it challenging to coat the straw;

Sample B—Did not dissolve as quickly as Sample A;

Sample C—Coating dissolved gradually, with no noticeable aggregates being released;

Sample D—Coating dissolved gradually, with minimal aggregates;

Sample E—Coating was releasing in chunky aggregates, particularly during the start of the study.

FIG. 9 shows that the sample having the highest percentage of maltodextrin (Sample A) released the least amount of CBD over the 30 minute period, while the sample having no maltodextrin (Sample E) released the greatest amount of CBD over the 30 minute period. However, as noted in the observations, the coating made from Sample E was releasing from the straw in chunky aggregates. This may have accounted for the high numbers attributed to Sample E, and these aggregates would produce an unpleasant experience for the user.

While a number of exemplary aspects and embodiments have been discussed above, those of skill in the art will recognize certain modifications, permutations, additions and sub-combinations thereof. It is therefore intended that the following appended claims are interpreted to include all such modifications, permutations, additions and sub-combinations as are consistent with the broadest interpretation of the specification as a whole.

1. A drinking straw having a coating on its interior surface, the drinking straw comprising:
the drinking straw; and
the coating applied on the interior surface of the straw, wherein the coating comprises:
an active ingredient;
a film forming agent;
a non-ionic surfactant;
and optionally a diluent.

2. The drinking straw according to claim 1, wherein the active ingredient is a flavouring, nutritional supplement, vitamin, mineral, pharmaceutical, nutraceutical or a combination thereof.

3. The drinking straw according to claim 1, wherein the active ingredient is vitamin D3 (cholecalciferol), ascorbic acid (vitamin C), docosahexenoic acid (DHA), caffeine, nicotine, ubiquinone (coenzyme Q10), curcumin, natural antioxidants, glucosamine, melatonin, vitamin B12, a biologically active metabolite thereof such as methylcobalamin, iron, analgesic compounds such as acetaminophen, aspirin, ibuprofen and naproxen, antihistamines such as loratadine, desloratadine, cetirizine, levocetirizine and fexofenadine, cough suppressants such as dextromethorphan and pseudoephedrine, guaifenesin, antacids, histamine-2 blockers, proton pump inhibitors, simethicone, loperamide, bismuth subsalicylate, dimenhydrinate, cannabinoids, or a combination thereof.

4. The drinking straw according to any claim 1, wherein the film forming agent is pullulan, alginate salts, starches, pectins, dextrins, gelatins, glycogen, poly(vinylalcohol) and its derivatives including polyvinylacetate, polyethyleneoxide, polyethyleneglycol, and polyvinylpyrrolidone (povidone), or a combination thereof.

5. The drinking straw according to claim 1, wherein the non-ionic surfactant is SPAN™ 80 and/or TWEEN™ 80.

6. The drinking straw according to claim 1, wherein the active ingredient is in a carrier oil comprising medium chain triglyceride (MCT) oil, avocado oil, sunflower oil, grapeseed oil, or hemp seed oil.

7. The drinking straw according to claim 1, further comprising maltodextrin.

8. A drinking straw comprising a coating on its interior face, the drinking straw comprising:
the drinking straw; and
the coating applied on the interior face of the straw, wherein the coating comprises:
30-55% w/w pullulan,
3-15% w/w MCT oil,
up to 30% of cannabinoid,
5-25% w/w glycerol,
0.5-4% of a combination of TWEEN™ 80 and SPAN™ 80, and
optionally 5-25% w/w maltodextrin.

9. A method of manufacturing a straw having a coating on its interior surface, the coating containing an active ingredient, the method comprising:
combining the active ingredient with a carrier, and blending to form a mixture;
adding a non-ionic surfactant and a plasticizer to the mixture;
agitating the mixture to form a homogeneous first dispersion;
adding a film forming agent to the first dispersion and mixing until homogeneous;
applying the dispersion to the interior surface of the straw;
agitating the straw to cover at least part of the interior surface with the first dispersion; and
drying the first dispersion inside the straw to form the coating.

10. The method of claim 9, further comprising adding maltodextrin to the mixture along with the non-ionic surfactant and the plasticizer.

11. The method of claim 9, wherein the active ingredient is a cannabinoid, the non-ionic surfactant is one or more of TWEEN™ 80 and SPAN™ 80, the plasticizer is glycerol, and the film forming agent is pullulan.

12. The method of claim 9, further comprising, after the first dispersion has dried, applying a second dispersion comprising a second active ingredient to the interior of the straw, agitating the straw to cover the dried first dispersion with the second dispersion, and drying the second dispersion inside the straw.

13. The method of claim 9, wherein only a portion of the interior surface of the straw is covered with the first dispersion, leaving an uncoated interior surface portion, the method further comprising, after the first dispersion has dried, applying a second dispersion having a second active ingredient to at least a portion of the uncoated interior surface, and drying the second dispersion inside the straw to at least partially coat the uncoated interior surface with the second dispersion.

14. The method of claim 13, wherein the first dispersion and the second dispersion are applied on the interior surface of opposing longitudinal sections of the straw.

15. The method of claim 13, wherein the first dispersion is applied circumferentially to the interior surface at a first end of the straw, the second dispersion is applied circumferentially to the interior surface at a second end of the straw, and there is no overlap between the first dispersion and the second dispersion.
